(19) United States
(12) Patent Application Publication
(10) Pub. No.: US 2015/0012226 A1
(43) Pub. Date: Jan. 8, 2015

(54) MATERIAL CLASSIFICATION USING BRDF SLICES

(71) Applicant: CANON KABUSHIKI KAISHA, Tokyo (JP)

(72) Inventor: SANDRA SKAFF, Mountain View, CA (US)

(73) Assignee: CANON KABUSHIKI KAISHA, Tokyo (JP)

(21) Appl. No.: 14/092,492

(22) Filed: Nov. 27, 2013

Related U.S. Application Data
(60) Provisional application No. 61/842,338, filed on Jul. 2, 2013.

(51) Int. Cl. G01N 21/55

(52) U.S. Cl. CPC G01N 21/55
USPC 702/22; 702/189

(57) ABSTRACT

Material classification using illumination by spectral light from multiple different incident angles, coupled with measurement of light reflected from the illuminated object of unknown material, wherein the incident angle and/or spectral content of each light source is selected based on a mathematical clustering analysis of training data, so as to select a subset of only a few light sources from a superset of many light sources.

### CROSS REFERENCE TO RELATED APPLICATION

The present application claims the benefit of priority under 35 U.S.C. §119(e) to provisional U.S. Application No. 61/842,338, filed on Jul. 2, 2013, the entire contents of which are incorporated by reference herein.

### FIELD

The present disclosure relates to material classification in which an object fabricated from an unknown material is illuminated with light, and light reflected therefrom is measured in an effort to identify the unknown material.

### BACKGROUND

In the field of material classification, it has been considered to classify material through the use of so-called bidirectional reflectance distribution function (BRDF). In this approach, the object is illuminated from multiple different angles by multiple different light sources arranged in a hemispherical dome around the object, and reflected light from each light source is measured so as to form the BRDF, whereafter feature vectors are derived and the unknown material from which the object is fabricated is classified.

It has also been considered to include the notion of spectral BRDF, in which each light source is formed from six (6) differently-colored LEDs, so as to permit spectral tuning of each light source, thereby to differentiate between different materials with increased accuracy.

### CITATIONS

1. Wang, O.; Gunawardane, P.; Scher, S. and Davis, J., “Material classification using BRDF slices”, CVPR, 2009.
2. Gu, J. and Liu, C., “Discriminative Illumination: Per-Pixel Classification of Raw Materials based on Optimal Projections of Spectral BRDF”, CVPR, 2012.
3. Gu, J., et al., “Classifying Raw Materials With Discriminative Illumination”, Project Home Page, Rochester Institute of Technology, <http://www.cis.rit.edu/jwgu/research/fisherlight/>, visited Jun. 19, 2013.

Citation [1] to Wang describes material classification using BRDFs (Bidirectional Reflectance Distribution Functions), and citation [2] to Gu describes spectral BRDFs. Additionally, in connection with citation [3] to Gu, a dataset of spectral BRDFs of material samples has been published in 2012 by RIT (see <http://compimg1.cis.rit.edu/data/metal/>). The dataset contains 100 material samples of 10 main categories. The setup for image capture constitutes a dome of 25 clusters, with 6 LEDs in each cluster. The method proposed by Gu in [2] computes the set of LEDs with their relative power needed to take the images of the materials in two shots for use in the classification algorithm.

### SUMMARY

One difficulty with the foregoing approach is the nature and number of the light sources. The hemispherical dome proposed by Gu in [2] is provided with twenty-five (25) clusters of light sources, with six differently-colored (6) LEDs in each cluster, for a total of one hundred and fifty (150) LEDs, each with controllable intensity. This results in a geometric and dimensional expansion of the illumination configurations with which the object is illuminated, together with a corresponding geometric and dimensional expansion of the measurements of data for each configuration of illumination, and a corresponding geometric and dimensional expansion of the analysis thereof.

In more detail, according to the approach described by Gu in citation [2], with respect to spectral BRDF-based features and coded illumination to classify materials, the imaging framework consists of an LED-based multispectral dome in which a hemispherical geodesic dome is provided with twenty-five (25) LED clusters. Each LED cluster has 6 color LEDs over the visible wavelength range, the colors of which are blue, green, yellow, red, white, and orange. The white LED is placed in the center of the cluster. Therefore there are 150 (25×6) LEDs in total. The approach proposed in [2] computes the power of illumination for each of the LEDs in the dome such that the images for each material would be captured in two shots. Therefore, using this approach for material classification, the entire dome and its arrangement of LEDs into 25 clusters are both required.

Embodiments described herein illustrate techniques whereby the number of clustered light sources can be reduced from a superset of many light sources down to a subset of far fewer light sources, without any significant loss in accuracy for material classification. For example, according to embodiments herein, the number of clustered light sources can be reduced from a superset of around twenty-five (25) light sources down to (for example) a subset of two or three light sources, without any significant loss in accuracy for material classification. In general, the technique involves the use of labeled training data for selection of the best two or three angular locations for incident angles of multispectral light sources which illuminate objects, together with selection of a suitable feature vector for capturing the reflection measurements with efficient dimensionality. Thereafter, armed with the two or three best locations for incident angles of illumination, together with the selected feature vector, a classification algorithm is trained, and objects of unknown materials are subjected to measurement and classification.

More specifically, given a database of labeled training data, captured under a relatively large number of light sources from different incident angles, a feature vector representation is calculated for the training data, and mathematical clustering (such as K-means clustering) is performed so as to identify two or three mathematically significant clusters of data for a corresponding two or three illumination angles. Based on these mathematical clusters, whose locations might not correspond to the physical locations of actual light sources, the angle of incident illumination and spectral content of the two or three best physical light sources are selected.

Thereafter, given the data from the selected physical light sources, and the selected feature vectors, a classification engine is trained using the training data. One classification engine might include an SVM (support vector machine) algorithm.

The results are thereafter applied to objects of unknown materials. In particular, an object of an unknown material is illuminated with the two or three optimally-selected light sources, and a feature vector is calculated from measurements obtained thereby. The feature vector is input into the trained classification algorithm, so as to obtain a classification estimate of the unknown material from which the object is fabricated.

Thus, one aspect of the description herein concerns material classification in which an object fabricated from an unknown material is positioned at a classification station which includes plural light sources each positioned at a predesignated incidence angle with respect to the object, and which further includes one or more image capture devices such as a digital camera each positioned at a predesignated exitant angle with respect to the object. At the classification station, the object is illuminated with light from the light sources, and an image of the light reflected from each illumination is captured by the capture device, so as to capture plural images each respectively corresponding to an illumination. The images are processed to extract BRDF slices and other feature vectors, and the feature vectors are inputted into a trained classification engine so as to classify the unknown material from which the illuminated object is fabricated.

The predesignated incident angles for the illumination from the light sources, and/or the spectral content of the light sources, are determined as described herein in connection with further embodiments. In one aspect, a labeled training sample is used for selection of the best few angular locations, such as the best two or three angular locations, for incident angles of multispectral light sources which illuminate objects. More specifically, given a database of labeled training data, captured under a relatively large number of light sources from different incident angles, a feature vector algorithm is applied to the captured image data for the training sample, so as to extract a feature vector, and mathematical clustering (such as K-means clustering) is performed so as to identify two or three mathematically significant clusters of data for a corresponding two or three illumination angles, and/or to identify two or three mathematically significant clusters of data for a corresponding two or three spectral wavelengths. Based on these mathematical clusters, whose locations and wavelengths might not correspond to the physical locations and wavelengths of actual light sources, the angle of incidence and/or spectral content of the two or three best physical light sources are selected.

Thereafter, given the data from the selected physical light sources, and the selected feature vectors, a classification engine is trained using the training data. One classification engine might include an SVM (support vector machine) algorithm.

These are provided as the predesignated incidence angles for the light sources, and/or the spectral content of the light sources, when classifying the material type of objects of unknown materials. In addition, when classifying object of unknown material, the same feature vector algorithm is applied to extract BRDFs and other feature vectors, and the trained classification engine is used.

Thus, in general, the disclosure herein is directed to material classification using illumination by spectral light from multiple different incident angles, coupled with measurement of light reflected from the illuminated object of unknown material, wherein the incident angle and/or spectral content of each illumination source is selected based on a mathematical clustering analysis of training data, so as to select a subset of only a few light sources from a superset of many light sources.

Further aspects described herein involve selection of incident illumination angles using spectral BRDF slices for material classification. Given a database of labeled training material samples captured under a relatively large number of incident illumination directions: (a) low-level feature vector representations are computed of these materials; (b) clustering, such as K-means clustering, is performed on the low-level features along the angle dimension to find the optimal directions of illumination; and (c) directions are selected for the optimal light source (such as LED) directions of the imaging setup which are closest to the directions provided by the estimated clusters, using an appropriate distance metric.

Thereafter, given the optimal light source directions as selected above, and the corresponding images obtained using them, the feature vector representations of the material samples are taken to be the low-level features computed using these images. Then: (a) a classification engine is trained, such as SVM, on the set of features of the training samples; (b) the trained classification engine is used along with an imaging setup including the optimal light source directions in a factory setting to obtain images of and to classify new material samples as observed.

The low-level feature vectors may be computed as the means of the intensities of the spectral BRDF slice images. The feature vectors may be obtained by application of a feature vector algorithm that computes the histogram over the clusters using all the spectral BRDF slices of a training sample. The distance metric can be the Euclidean distance, L1 or other appropriate metrics.

The training images in the labeled training sample may be labeled by material by calculating a probability function based on determining a correlation between a sample signature and a set of pre-labeled signatures in a database. In this regard, reference is made to U.S. Application No. 61/736,130, filed Dec. 12, 2012 by Francisco Imai, “Systems And Methods For Material Classification Based On Decomposition Of Spectra Into Sensor Capturing And Residual Components”, the contents of which are incorporated by reference herein, as if set forth in full.

The number of optimal incident illumination angles may be selected automatically using a mathematical clustering algorithm such as convex clustering. The clusters may then be computed using K-means, Gaussian Mixture Models, or other appropriate algorithms. Material classifications may include material sub-categories.

The classification engine may be configured to make a decision for cases with a pre-determined level of confidence in the prediction. When a decision is not made, the sample can be sent to a human for labeling.

In addition, although some embodiments may be based on a one-time training of the classification engine, in other embodiments, the classification engine may be trained more than once, or may be updated at intervals, such as by training on-line with new material samples. In this regard, and particularly with respect to objects not classified with confidence by the engine, and for which a manual classification was needed, the training for the classification engine can be updated using the manually-classified result.

Aspects described herein include selection of incident illumination angles for illumination of an object by respective light sources, wherein the incident illumination angle of each light source is selected based on a mathematical clustering analysis of labeled training data captured under a superset of a second number of light sources from different incident angles, so as to select a subset of incident illumination angles by a first number of light sources from the superset of the second number of light sources, the first number being smaller than the second number. There may include calculating a feature vector representation for training data in a database of labeled training data captured under the superset of the second number of light sources from different incident angles; performing mathematical clustering on the feature vector representations so as to identify a subset of mathematically significant clusters of data for a corresponding first number of incident illumination angles; and selecting incident illumination angles for the light sources based on the mathematical clusters.

According to such aspects, directions for the incident illumination angles for the light sources may be selected using a distance metric selected from a group consisting essentially of a Euclidean distance metric and an L1 distance metric. The mathematical clustering may include clustering by a clustering algorithm selected from a group consisting essentially of K-means clustering and Gaussian Mixture Models clustering. BRDF (bidirectional reflectance distribution function) slices may be used. The feature vectors may comprise means of intensities of the BRDF slices; or histograms over features of the spectral BRDF slices of a training sample; or may be obtained by application of a feature vector algorithm that computes the histogram over the clusters using all the spectral BRDF slices of a training sample.

Further according to such aspects, the training data may be captured from a superset of a relatively large number of exitant angle, and there may include selecting a subset of a relatively small number of mathematically significant clusters of data for a corresponding small number of exitant angles by using mathematical clustering.

Further according to such aspects, the number of mathematically significant clusters may be selected automatically using a mathematical clustering algorithm which may include convex clustering. Each light source in the database of labeled training data may comprise a multi-spectral light source, and there may include selecting a subset of a relatively small number of mathematically significant clusters of illumination spectra for subset of incident illumination angles by using mathematical clustering.

Further according to such aspects, the database of labeled training data may comprise a database of labeled training material samples captured in an imaging configuration under a relatively large number of incident illumination directions. The feature vector may be calculated by computing low-level feature vector representations of such materials; and the mathematical clustering may be performed on the low-level features along an angle dimension to find optimal directions of illumination. Selecting incident angles may comprise selecting directions for the optimal light source of the imaging configuration which are closest to directions provided by the mathematical clusters. Directions for the optimal light sources may be selected using a distance metric selected from a group consisting essentially of a Euclidean distance metric and an L1 distance metric. The low-level feature vectors may be computed as the means of the intensities of spectral BRDF slices.

Further according to such aspects, the illuminated object is fabricated from an unknown material and is illuminated by the light sources for material classification, and there may comprise training a classification engine for material classification, wherein the classification engine is trained using feature vectors calculated from training data corresponding to light sources for the selected incident angles. The classification engine may include an SVM (support vector machine) algorithm. Material classification may include material sub-categories. The classification engine may be configured to make a decision for cases with a pre-determined level of confidence. In response to failure of the classification engine to make a decision, the object may be subjected to manual labeling. The classification engine may be trained multiple times for updating of its training by new material samples. The classification engine may be configured to make a decision for cases with a pre-determined level of confidence, and in response to failure of the classification engine to make a decision with confidence by the engine, the object may be subjected to manual labeling, and the training for the classification engine may be updated using the manually-classified result. There may further comprise capturing reflected light information from an object of unknown material illuminated in an imaging configuration that includes the selected optimal light source directions; and applying the trained classification engine to the captured light information to classify the material of the illuminated object.

Aspects described herein also include material classification of an object fabricated from an unknown material, comprising illuminating an object by spectral light from multiple different incident angles using multiple light sources; measuring light reflected from the illuminated object; and classifying the material from which the object is fabricated using the measured reflected light. The incident illumination angle of each light source is selected based on a mathematical clustering analysis of labeled training data captured under a superset of light sources from different incident angles, so as to select a subset of incident illumination angles by first number of light sources from a superset of second number of light sources, the first number being smaller than the second number.

According to such aspects, classification may comprise applying a trained classification engine to the captured light information to classify the material of the illuminated object. The classification engine may be trained using feature vectors calculated from training data corresponding to light sources for the selected incident angles. The classification engine may be trained multiple times for updating of its training by new material samples. The classification engine may be configured to make a decision for cases with a pre-determined level of confidence, and in response to failure of the classification engine to make a decision with confidence by the engine, the object may be subjected to manual labeling, and the training for the classification engine may be updated using the manually-classified result.

Aspects described herein also include material classification of an object fabricated from an unknown material, comprising illuminating an object positioned at a classification station by plural light sources each positioned at a predesignated incidence angle with respect to the object; capturing plural images of light reflected from the illuminated object, each of the plural images corresponding respectively to illumination by a respective one of the plural light sources; extracting a respective plurality of feature vectors from the plural captured images by using a feature vector algorithm; and processing the plurality of feature vectors using a trained classification engine so as to classify the unknown material of the object. The predesignated incident angles are determined by calculating a feature vector representation for training data in a database of labeled training data captured under a superset of a second number of light sources light sources from different incident angles, so as to select a subset of incident illumination angles by a first number of light sources from the superset of the second number of light sources, the first number being smaller than the second number, wherein the feature vector is calculated using the feature vector algorithm; performing mathematical clustering on the feature vector representations so as to identify a subset of mathematically significant clusters of data for a corresponding the first number of incident illumination angles; and selecting incident illumination angles for the light sources based on the mathematical clusters. The classification engine is trained by using feature vectors calculated from training data corresponding to light sources for the selected incident angles.

According to such aspects BRDF (bidirectional reflectance distribution function) slices may be used. The feature vectors may comprise means of intensities of the BRDF slices. The feature vectors may comprise histograms over features of the spectral BRDF slices of a training sample. The feature vectors may be obtained by application of a feature vector algorithm that computes the histogram over the clusters using all the spectral BRDF slices of a training sample.

Further according to such aspects, material classification may include material sub-categories. The classification engine may be configured to make a decision for cases with a pre-determined level of confidence. In response to failure of the classification engine to make a decision, the object may be subjected to manual labeling. The classification engine may be trained multiple times for updating of its training by new material samples. The classification engine may be configured to make a decision for cases with a pre-determined level of confidence, and in response to failure of the classification engine to make a decision with confidence by the engine, the object may be subjected to manual labeling, and the training for the classification engine may be updated using the manually-classified result.

Further according to such aspects, each light source in the database of labeled training data may comprise a multi-spectral light source, and there may further comprise selecting a subset of a relatively small number of mathematically significant clusters of illumination spectra for each of incident illumination angle in the subset of incident illumination angles by using mathematical clustering; training the classification engine using feature vectors calculated from training data corresponding to light sources for the selected illumination spectra; and illuminating the object with the selected illumination spectra.

This brief summary has been provided so that the nature of this disclosure may be understood quickly. A more complete understanding can be obtained by reference to the following detailed description and to the attached drawings.

### BRIEF DESCRIPTION OF THE DRAWINGS

FIG. 1 is an example embodiment of a classification system according to the description herein, in the form of a recycling system in which objects to be recycled are classified according to the materials from which the objects are fabricated, and the classified objects are sorted for recycling according to their material classification.

FIG. 2 is a more detailed view of an object being subjected to classification at a classification station of the FIG. 1 view.

FIG. 3 is a view for explaining the architecture of a classification and sorting controller.

FIG. 4 illustrates an embodiment in which a training sample of objects fabricated from known materials is subjected to illumination from a large number of light sources at a respectively large number of incident angles.

FIG. 5 is a view for explaining the architecture of a controller and analyzer for light source configurations.

FIG. 6 is a flow diagram illustrating the general flow of processing performed by an embodiment of a light source configuration controller and analyzer.

FIGS. 7 and 8 are views illustrating a framework for a determination of the incident angle for plural light sources used for material classification, and for a determination of the number of light sources, according to an embodiment described herein.

### DETAILED DESCRIPTION

Approaches previously considered for spectral BRDF-based features for material classification use large numbers of sight sources and corresponding image captures, such as 150 LEDs for capturing the material images. As described previously, the LEDs are clustered into groups of six (6) LEDs each, yielding twenty-five (25) clusters in total. Building a dome with 150 LEDs to deploy in a factory or other industrial robotic application setting is cumbersome and difficult to maintain. In this description, therefore, there is a selection of the most discriminative LED clusters, corresponding to incident illumination angles, which would be sufficient to image and to classify a set of given materials. With this approach, as few as only 2 or 3 LED clusters or incident illumination angles (12 or 18 spectral BRDF slices) can be used, while not compromising on the accuracy of material classification.

In this discussion, it is assumed that all LEDs in one cluster have the same incident illumination angle. This is a valid assumption since the difference in the incident angle illumination for the LEDs is very small and can be attributed to noise in a real-world setting.

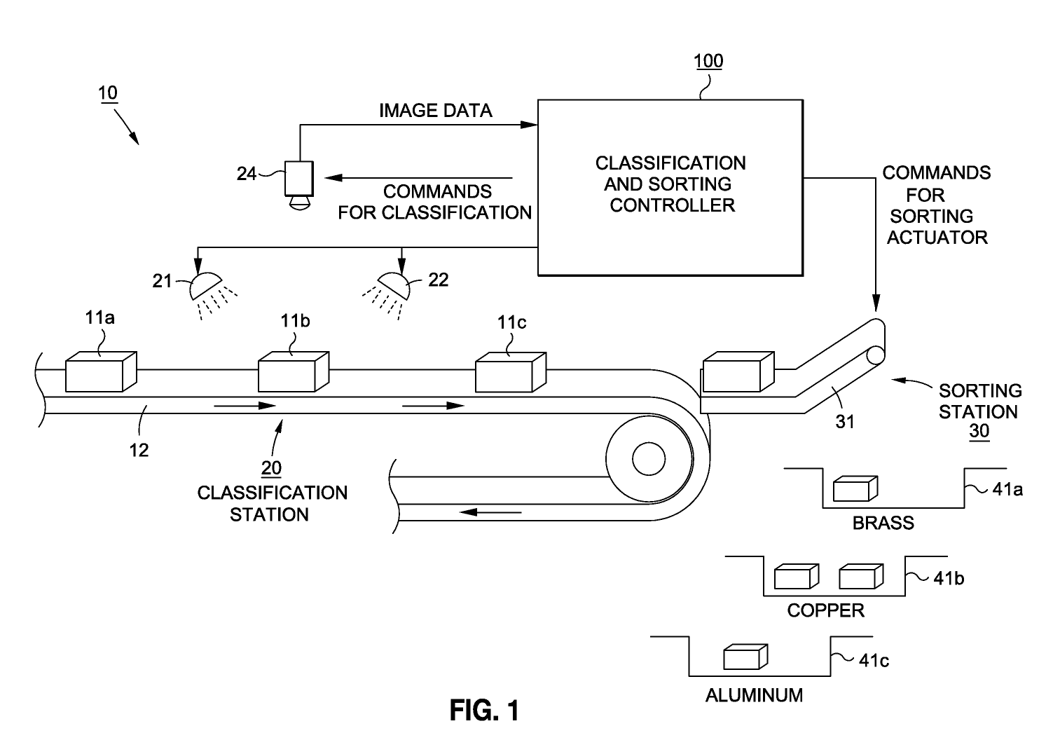

FIG. 1 is an example embodiment of a classification system according to the description herein, in the form of a recycling system 10 in which objects to be recycled are classified according to the materials from which the objects are fabricated, and the classified objects are sorted for recycling according to their material classification. As shown in FIG. 1, objects 11a, 11b, etc. are conveyed on a conveyor mechanism 12 to a classification station 20, where the objects are classified according to their material, and thence to a sorting station 30, where the objects are sorted according to their material classification. Classification station 20 includes plural light sources 21 and 22, together with a camera 24 for capturing images of objects positioned at classification station 20. The object at the classification station is illuminated individually by each of the plural light sources under control of classification and sorting controller 100, and camera 24 captures one or more images for each individual illumination. Under control of the classification and sorting controller 100, a classification is made for the material from which the object is fabricated.

Conveyor mechanism 12 continues to convey the object to sorting station 30, where sorting actuator 31 sorts the objects according to the material classification. Sorting is controlled by classification and sorting controller 100, which commands actuator mechanism 31 to sort the classified objects into multiple receptacles 41a, 41b and 41b.

In this example embodiment, material classification differentiates between different types of metals from which the objects are fabricated, such as brass, copper and aluminum. Naturally, it will be understood that this is a non-limiting example. In other embodiments, material classification could differentiate between metal, plastic and glass, between fabric and paper, between different types or colors of plastics and glass, and so forth, or between any and all of these. In addition, other embodiments might include a classification of “unknown”, signifying that material classification did not succeed with confidence, with a corresponding receptacle for which manual sorting is required.

A description will now be made of the angular positioning of the plural light sources and the camera relative to the object at the classification station, the spectral content of the light sources, and the spectral sensitivity of the camera.

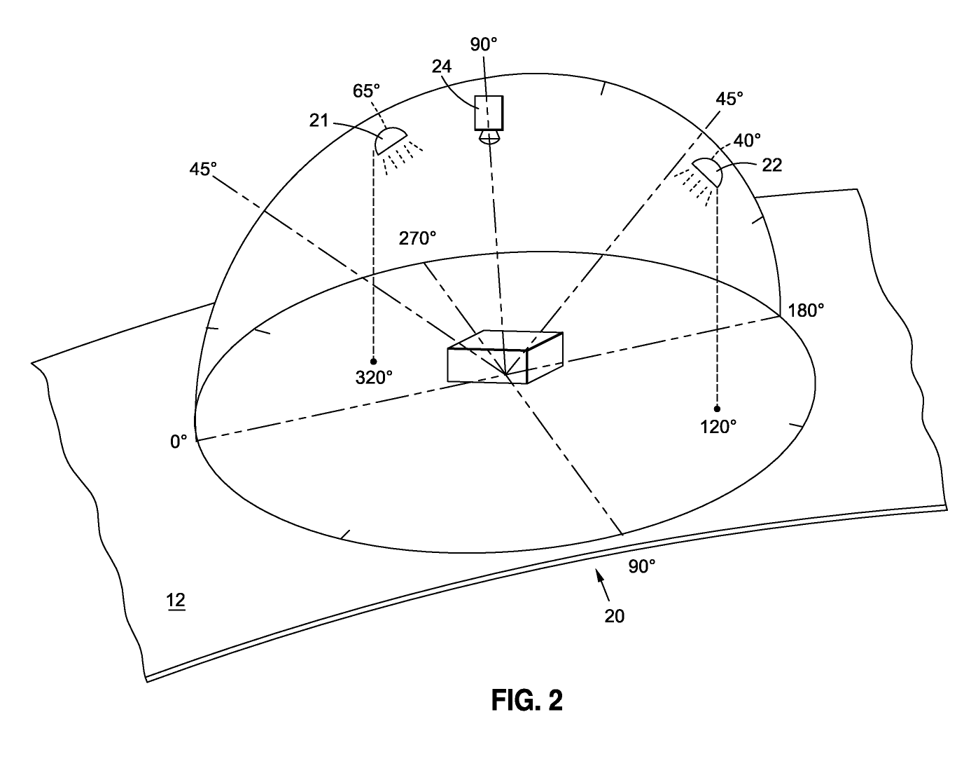

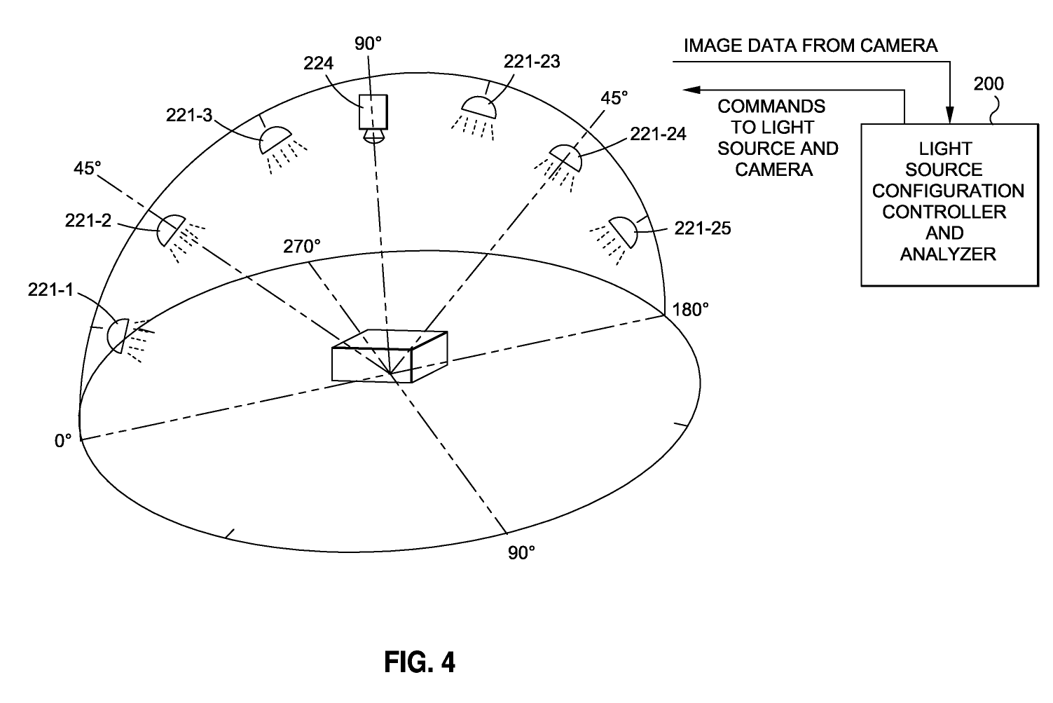

FIG. 2 is a more detailed view of an object on conveyor mechanism 12 at classification station 20. In this figure, an angular coordinate system has been superimposed for purposes of explanation, and for purposes of explaining the angle of incidence for each of light sources 21 and 22, and the angle of exitant for light reflected from the object and imaged by camera 24. In this example embodiment, light source 21 is positioned at an incident angle of 320 degrees azimuth and 65 degrees elevation; and light source 22 is positioned at an incident angle of 120 degrees azimuth and 40 degrees elevation. Also in this example, camera 24 is positioned at an exitant angle of 90 degrees elevation. The derivation and calculation for these incident and exitant angles are described in greater detail below in connection particularly with FIGS. 4 through 8.

With respect to the spectral content of light sources 21 and 22, each light source is formed from an LED cluster with six (6) differently-colored LEDs arranged circularly with a white LED in the center. In this embodiment, the LEDs cover the visible wavelength range, and include the colors of blue, green, yellow, red, orange and the afore-mentioned white. In other embodiments, it might be helpful to include LEDs beyond the visible wavelength, such as LEDs which emit light in the ultraviolet or infrared range. The precise spectral content of the light sources is discussed in greater detail below, but in general will assist in distinguishing between different classifications of materials.

Camera 24 in this embodiment is a RGB camera, and it thus exhibits spectral sensitivity in each of the red, green and blue wavelengths. In other embodiments, camera 24 might include spectral sensitivity in wavelengths other than red, green, and blue, or it might include a monochrome camera which exhibits broad spectral sensitivity across the visible and near-visible ranges of wavelengths, possibly along with a liquid crystal tunable filter.

As shown in FIG. 2, this example embodiment includes two (2) light sources and one (1) camera. The determination of the number of light sources, together with their incident angles, is discussed below in greater detail, particularly with respect to FIGS. 4 through 8. Likewise, the number of cameras, together with their exitant angles, is discussed in greater below in connection with the same figures. In general, however, in order to facilitate rapid classification of materials, such as real-time classification of materials, the number of light sources, and the number of cameras is relatively small, such that materials can be classified with only a few illuminations and with only a few images for each such illumination. Preferably, the number of light sources should range between two and five, inclusive, most preferable two or three light sources, and the number of cameras should range between one and two, inclusive, most preferably one camera.

Although in this embodiment the spectral content of each individual light source is identical to all others, it should be understood that the spectral content of the light sources might differ from each other. Likewise, in embodiments where there are plural cameras, although the spectral sensitivities of the cameras might match, it is also possible for the spectral sensitivities to differ.

Under control of classification and sorting controller 100, each individual LED in each individual light source of the plural light sources is illuminated individually and independently of other LEDs in the light source, and independently and individually of other light sources and other LEDs in those other light sources. For each such illumination, camera 24 captures an image of light reflected from the object at the exitant angle. The captured images are collected by classification and sorting controller 100, and are analyzed thereby, such as by deriving one slice of the so-called bidirectional reflectance distribution function (BRDF). The BRDF is a four-dimensional function that depends on incident and exitant angles, and defines how light is reflected from the surface of an object. With a camera positioned at a fixed exitant angle, only a “slice” of the BRDF is obtained.

Based on the BRDF slices, and other analysis which includes application of a feature vector algorithm to extract feature vectors for each image, and feeding of such feature vectors to a trained classification engine, classification and sorting controller 100 obtains a classification of the material from which the illuminated object is fabricated.

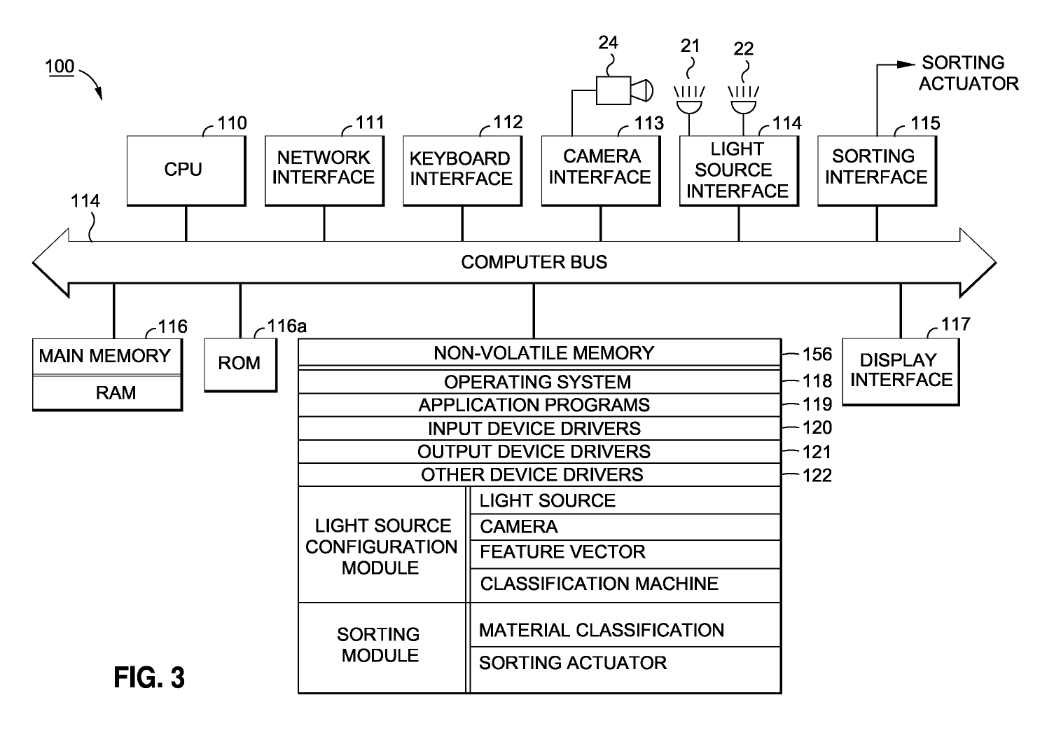

FIG. 3 is a view for explaining the architecture of classification and sorting controller 100.

As shown in FIG. 3, classification and sorting controller 100 includes central processing unit (CPU) 110 which interfaces with computer bus 114. Also interfacing with computer bus 114 are non-volatile memory 156 (e.g., a hard disk or other nonvolatile storage medium), network interface 111, keyboard interface 112, camera interface 113, random access memory (RAM) 116 for use as a main run-time transient memory, read only memory (ROM) 116a, and display interface 117 for a display screen or other output.

RAM 116 interfaces with computer bus 114 so as to provide information stored in RAM 116 to CPU 110 during execution of the instructions in software programs, such as an operating system, application programs, image processing modules, and device drivers. More specifically, CPU 110 first loads computer-executable process steps from non-volatile memory 156, or another storage device into a region of RAM 116. CPU 110 can then execute the stored process steps from RAM 116 in order to execute the loaded computer-executable process steps. Data, also, can be stored in RAM 116 so that the data can be accessed by CPU 110 during the execution of the computer-executable software programs, to the extent that such software programs have a need to access and/or modify the data.

As also shown in FIG. 3, non-volatile memory 156 contains computer-executable process steps for operating system 118, and application programs 119, such as graphic image management programs. Non-volatile memory 156 also contains computer-executable process steps for device drivers for software interface to devices, such as input device drivers 120, output device drivers 121, and other device drivers 122.

Non-volatile memory 156 also stores a material classification module and a sorting module. The material classification module and the sorting module comprise computer-executable process steps for material classification of an object fabricated from an unknown material, and for sorting the object based on the material classification.

The computer-executable process steps for these modules may be configured as part of operating system 118, as part of an output device driver in output device drivers 121, or as a stand-alone application program. These modules may also be configured as a plug-in or dynamic link library (DLL) to the operating system, device driver or application program. It can be appreciated that the present disclosure is not limited to these embodiments and that the disclosed modules may be used in other environments.

The material classification module includes a corresponding plurality of modules for control of the light sources, for control of the camera(s) and for gathering of image data of such camera(s) a module for derivation of feature vectors according to a feature vector algorithm, such as feature vectors based on BRDF slices, and a classification machine. The classification machine accepts as inputs the feature vectors derived by the feature vector module, and provides a classification of the material from which the object under inspection is fabricated.

More details concerning the nature of the feature vector algorithm and the classification machine are provided below, in connection with FIGS. 4 through 8.

The sorting module for its part includes a corresponding plurality of modules related to input of material classification from the classification machine, and actuation of the sorting mechanism based on the classification.

FIGS. 4 through 8 describe a further embodiment according to the description herein. These figures are used to describe the determination and calculation of the angular placement for the plural light sources depicted in FIG. 1, the angular placement of the camera(s) depicted in FIG. 1, the spectral content of the plural light sources, and the spectral sensitivity of the camera.

In particular, FIGS. 4 through 8 describe an embodiment in which a training sample of objects fabricated from known materials is subjected to illumination from a large number of light sources at a respectively large number of incident angles, together with the capture of a corresponding large number of images by one or more cameras of BRDF slices and other feature vectors are calculated from the captured images, and a mathematical clustering is performed on the feature vectors so as to identify a relatively small number of incident angles of light sources, and/or spectral content thereof, with the most significant aptitude for distinguishing between materials. A classification machine is trained using the feature vectors corresponding to the identified clusters, using the labels from the labeled training sample.

In one example embodiment depicted in FIG. 4, there are twenty-five (25) light sources (221-1, 221-2, 221-3, . . . , 221-23, 221-24 and 221-25) arranged uniformly over a hemispherical dome surrounding a labeled object in the training sample, and one camera 224 positioned at a predetermined exitant angle such as 90 degrees elevation. Each light source may include six (6) differently-colored LEDs arranged in a circular cluster consisting of colors blue, green, yellow, red, orange and white, with white arranged at the center of the cluster. Each of the six (6) LEDs in each light source is illuminated independently, over all twenty-five (25) light sources, with the camera capturing an image of light reflected from the labeled training sample, for a total of one hundred and fifty (150) images for each labeled object in the training sample. After a similar capture of one hundred and fifty (150) images for each of the multiple labeled objects in the training set, feature vectors using the BRDF slices are derived (by application of a feature vector algorithm) for each captured image. The low-level feature vectors may be computed as the means of the intensities of the spectral BRDF slice images. The feature vectors may be obtained by application of a feature vector algorithm that computes the histogram over the clusters using all the spectral BRDF slices of a training sample. The distance metric can be the Euclidean distance, L1 or other appropriate metrics. The feature vectors are subjected to mathematical clustering so as to identify a small number of the better incident angles of the light sources, and/or the better spectral content thereof, with these mathematical clusters having the most significant aptitude for distinguishing between materials. The number of mathematical clusters should be relatively small; preferably, the number of clusters ranges between two and five clusters, inclusive. The number of mathematical clusters so-identified determines the number of light sources, the incident angles thereof, and their spectral content, for the classification system depicted in FIG. 1.

Likewise, the number of cameras, and the spectral sensitivity thereof, may also be determined by mathematical clustering. Again, the number of mathematical clusters as so-identified, and the spectral sensitivities thereof, are determinative of the number of cameras in the classification system depicted in FIG. 1, the exitant angle thereof, and their spectral sensitivities.

In one preferable arrangement, the spectral content of the light sources in the FIG. 4 embodiment is identical to the spectral content of a corresponding light source in the FIG. 1 classification system. Likewise, the spectral sensitivity of the camera is identical to that of the camera shown in the FIG. 1 classification system. It should be understood, however, that the spectral content of the light sources, and the spectral sensitivity of the camera, might in some embodiments be different.

In FIG. 4, for purposes of clarity and illustration, only six (6) light sources are depicted, at 221-1, 221-2, 221-3, 221-23, 221-24 and 221-25. In fact, in this embodiment, there are a total of twenty-five (25) light sources arranged uniformly over a hemispherical dome surrounding the labeled object in the training sample.

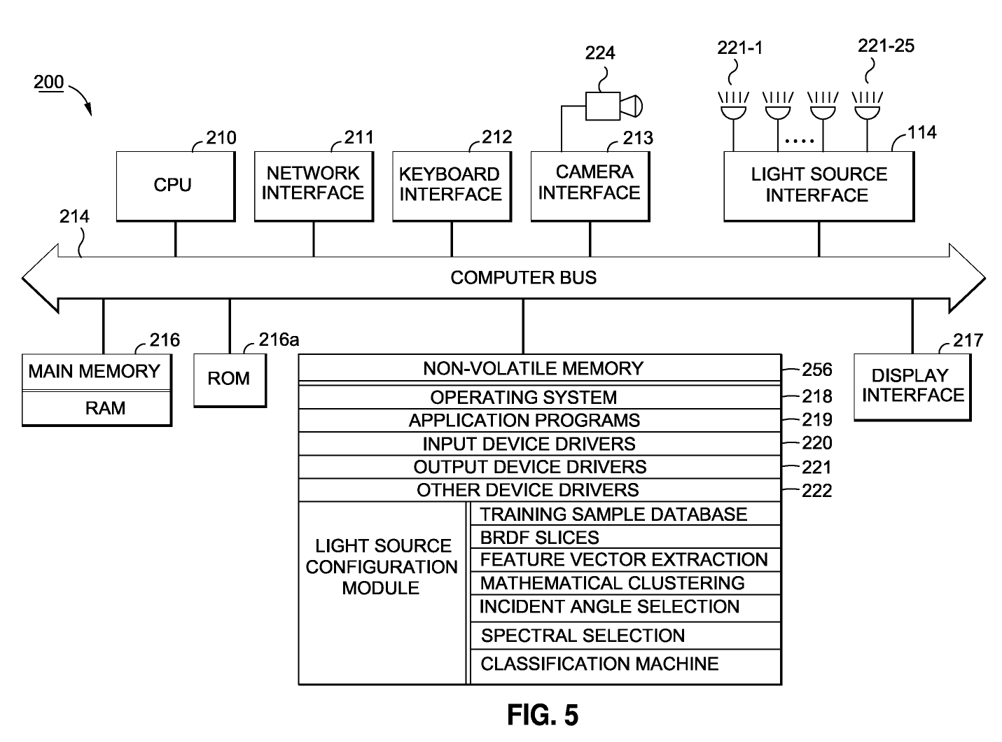

Operation of the FIG. 4 embodiment proceeds under control of the light source configuration controller and analyzer 200. FIG. 5 illustrates more details concerning the internal architecture of light source configuration controller and analyzer 200.

As shown in FIG. 5, light source configuration controller and analyzer 200 includes central processing unit (CPU) 210 which interfaces with computer bus 214. Also interfacing with computer bus 214 are non-volatile memory 256 (e.g., a hard disk or other nonvolatile storage medium), network interface 211, keyboard interface 212, camera interface 213, random access memory (RAM) 216 for use as a main run-time transient memory, read only memory (ROM) 216a, and display interface 217 for a display screen or other output.

RAM 216 interfaces with computer bus 214 so as to provide information stored in RAM 216 to CPU 210 during execution of the instructions in software programs, such as an operating system, application programs, image processing modules, and device drivers. More specifically, CPU 210 first loads computer-executable process steps from non-volatile memory 256, or another storage device into a region of RAM 216. CPU 210 can then execute the stored process steps from RAM 216 in order to execute the loaded computer-executable process steps. Data, also, can be stored in RAM 216 so that the data can be accessed by CPU 210 during the execution of the computer-executable software programs, to the extent that such software programs have a need to access and/or modify the data.

As also shown in FIG. 5, non-volatile memory 256 contains computer-executable process steps for operating system 218, and application programs 219, such as graphic image management programs. Non-volatile memory 256 also contains computer-executable process steps for device drivers for software interface to devices, such as input device drivers 220, output device drivers 221, and other device drivers 222.

Non-volatile memory 256 also stores a light source configuration module. The light source configuration module comprises computer-executable process steps for determining, from the superset of all incident angles and spectral content of all light sources, which in this embodiment is twenty-five (25) light sources, and from the superset of all exitant angles and spectral sensitivities of all cameras, which in this embodiment is a single camera, a satisfactory subset by which material classification of an object fabricated from an unknown material may be made accurately and without any significant loss in accuracy as compared to material classification made by the superset.

The computer-executable process steps for these modules may be configured as part of operating system 218, as part of an output device driver in output device drivers 221, or as a stand-alone application program. These modules may also be configured as a plug-in or dynamic link library (DLL) to the operating system, device driver or application program. It can be appreciated that the present disclosure is not limited to these embodiments and that the disclosed modules may be used in other environments.

The light source configuration module includes a corresponding plurality of modules including a module for storing a database of the labeled training sample, a module for calculation and storage of the BRDF slices, a module for extracting feature vectors in accordance with application of an algorithm for feature vectors, a module for performing mathematical clustering, a module to select incident angles for each mathematical cluster identified by the mathematical clustering algorithm, a module for selecting spectral content of light sources, and a module for storing and training a classification machine.

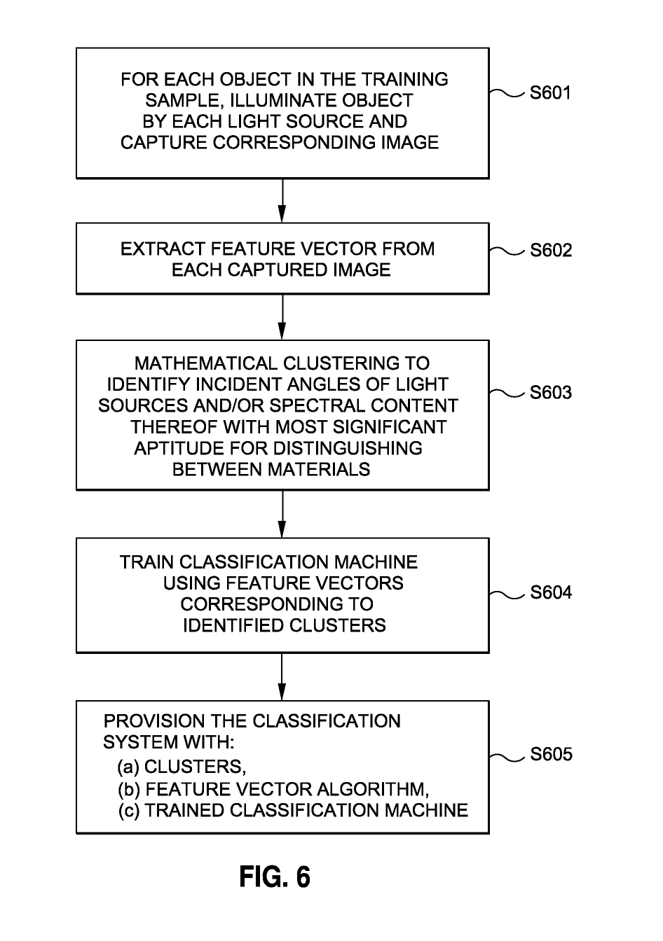

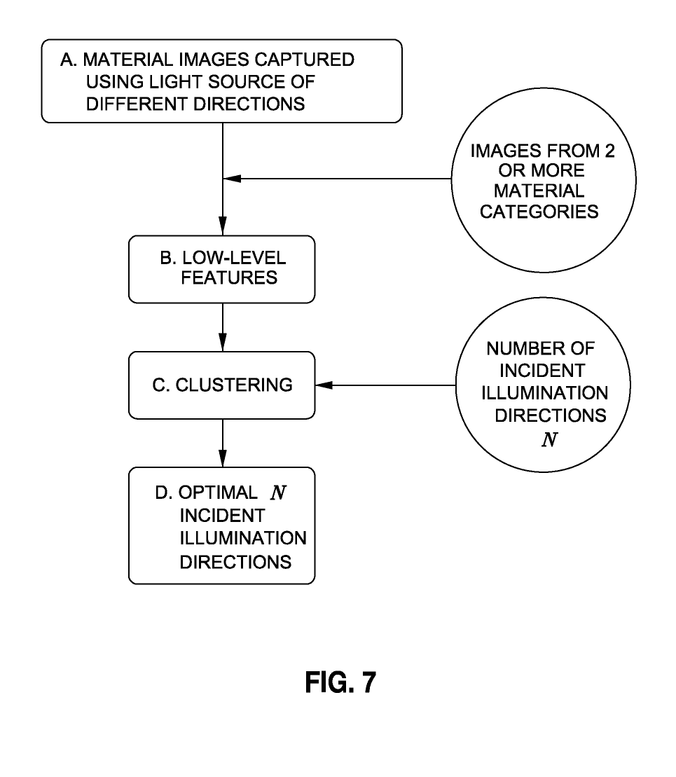

FIG. 6 is a flow diagram illustrating the general flow of processing performed by light source configuration controller and analyzer 200. In step S601, for each labeled object in the training sample the object is illuminated in turn by each of the twenty-five (25) light sources 221-1 . . . 221-25, and individually and independently for each of the six (6) differently-colored LEDs in each such light source, with a corresponding image being captured at the exitant angle by camera 224. After all labeled objects in the training sample have been illuminated, and corresponding images captured, step S602 calculates BRDF slices and extracts feature vectors from each captured image. The nature of the feature vectors is described below in connection with FIG. 7. In general, the nature of the feature vectors depends on the nature of the classification challenge, and might include, for example, feature vectors extracted by application of a histogram-based feature vector algorithm.

In step S603, mathematical clustering is performed on the extracted feature vectors, so as to identify clusters of incident angles for the light sources, and/or spectral content thereof, with the most significant aptitude for distinguishing between materials. The nature of the mathematical clustering might include, for example, K-means clustering. The mathematical clustering is performed so as to identify two or three mathematically significant clusters of data for a corresponding two or three incident illumination angles.

The clusters identified in step S603 might not correspond to actual incident angles of any one of the twenty-five (25) light sources. Likewise, if clustering is performed for spectral content, the mathematical clusters might not correspond exactly to the actual spectral content of the light sources. In such cases, the actual light sources and spectral content closest to the mathematical clusters, and the feature vectors corresponding to these actual locations and spectral content, are selected for further processing.

In step S604, a classification machine is trained using feature vectors corresponding to the identified clusters. The classification machine might include an SVM (support vector machine) algorithm.

In step S605, a classification system such as that depicted in FIG. 1 is provisioned with the results. In particular, the classification system is provisioned with the clusters identified by the mathematical clustering, the algorithms selected for extraction of feature vectors, and the trained classification machine. Thereafter, and returning to the classification system depicted in FIG. 1, given an object fabricated from an unknown material, the classification system of FIG. 1 illuminates the object with light sources whose incident angle and/or spectral content are determined in step S603, and images from each illumination are captured by camera 24. In this embodiment, camera 24 is positioned at an exitant angle identical to that of camera 224, and the spectral sensitivity of camera 24 is identical to that of camera 224. In other embodiments, where mathematical clustering is performed so as to identify an optimal position or positions for camera(s) 24, or spectral sensitivities for such camera, camera(s) 24 is positioned at an exitant angle in accordance with the mathematical clustering, and its spectral sensitivity is matched to that of the mathematical clustering.

Thereafter, based on the captured image data, the classification system of FIG. 1 applies the feature vector algorithm provisioned in step S605, so as to derive BRDF slices and other feature vectors from the captured images. The feature vectors as so-calculated are fed to the trained classification machine, so as to result in a classification of material for the illuminated object.

FIG. 7 illustrates a further embodiment of a light source configuration controller and analyzer. This further embodiment is somewhat more specifically tailored to the classification of different types of metals, using the dataset published by Gu in connection with citation [3].

It is again appropriate to note that approaches previously considered for spectral BRDF-based features for material classification use large numbers of sight sources and corresponding image captures, such as 150 LEDs for capturing the material images. As described previously, the LEDs are clustered into groups of six (6) LEDs each, yielding twenty-five (25) clusters in total. Building a dome with 150 LEDs to deploy in a factory or other industrial robotic application setting is cumbersome and difficult to maintain. In this description, therefore, there is a selection of the most discriminative LED clusters, corresponding to incident illumination angles, which would be sufficient to image and to classify a set of given materials. With this approach, as few as only 2 or 3 LED clusters or incident illumination angles (12 or 18 spectral BRDF slices) can be used, while not compromising on the accuracy of material classification.

In this discussion, it is assumed that all LEDs in one cluster have the same incident illumination angle. This is a valid assumption since the difference in the incident angle illumination for the LEDs is very small and can be attributed to noise in a real-world setting. It is also an appropriate assumption given that this explanation is using LED clusters specific to the type of data provided by Gu in his dataset. It is possible that each light source or some of them might include only a single LED and not a cluster of LEDs. In such a case, clustering of the spectra for the light sources might not be applicable.

The framework of this embodiment is shown in FIG. 7, which illustrates a framework for selecting incident illumination angles using spectral BRDFs for material classification. In a first explanation, the steps of the framework are described. In a second explanation, there is a description of how different feature vectors can be computed using the optimal LED clusters or incident illumination angles. One type of feature requires only 12 or 18 spectral BRDF slices. The second type is computed using all 150 spectral BRDF slices in addition to the optimal LED clusters or incident illumination angles. A verification is provided using the dataset given by Gu at citation [3], to the effect that the feature vectors computed using the optimal incident illumination angles provide competitive accuracy in material classification, in the sense that by using a subset of only two or three (first number) light sources at incident angles determined by mathematical clustering, material classification can be achieved at an accuracy not significantly worse than the accuracy provided by the superset of all twenty-five (25) (second number) light sources.

The steps of the framework depicted in FIG. 7 will now be explained (i.e., the first explanation mentioned above).

At (A) in FIG. 7, the images are obtained from the RIT dataset given by Gu in connection with citation [3] (see <http://compimg1.cis.rit.edu/data/metal/>). This dataset contains 10 samples in each of 10 material categories to add up to 100 samples in total. Each material sample is imaged 150 times using each of the LEDs of the dome as described previously. Thus, at (A), images are obtained corresponding to images of materials captured using light sources of different directions.

At (B) of FIG. 7, given the training samples belonging to material categories for which the optimal set of incident illumination angles will be computed, the low-level features are computed. These are denoted by X={xₜ, where t=1 . . . T}, where xₜ is the feature, in this case the mean value, for one slice and T=150 is the number of slices. For each material sample, the mean over all the pixels of a cropped region is taken for each of the 150 slices. The features are concatenated yielding a 150D (dimensional) feature vector for each material.

At (C) of FIG. 7, the incident illumination angles to be selected correspond to those of the LED clusters in the imaging setup. The number of LED clusters N is inputted by the user. Given a set of training samples belonging to one material category, all the 150D low-level feature vectors as described in (B) for each material are placed into 25×M matrices. M is the number of LEDs in each cluster, which is 6 in this case. Next the aggregated low-level features for all the training data are clustered into N clusters, since one purpose of this framework is to select the N LED clusters. Note that there is a slight difference between the terms “clusters” and “LED cluster(s)” as referred to in this document. The former refers to the mathematical clusters as computed by the mathematical clustering algorithm, while the latter refers to the actual clusters of LEDs in the imaging setup dome. The 25×M matrices for each material are used to perform K-means clustering or Gaussian Mixture Models clustering to obtain the most representative N clusters of the data. As such, the set of means for the clusters, μᵢ where i=1 . . . N, is obtained where each mean μᵢ is of dimension M. In other embodiment, a convex clustering algorithm can be used, whereby the number of most representative clusters N is automatically determined by the algorithm.

At (D) of FIG. 7, given the cluster means as computed in (C), the N optimal LED clusters from the imaging dome are then selected. Each cluster mean is used to search through the 25×M matrices for all material samples to find the LED cluster with minimum distance to it. The angle corresponding to the intensity values in the M dimensional row of the matrix would be the optimal angle. The same is repeated for obtaining the remainder of the optimal LED clusters, resulting in a subset of N optimal directions for incident illumination.

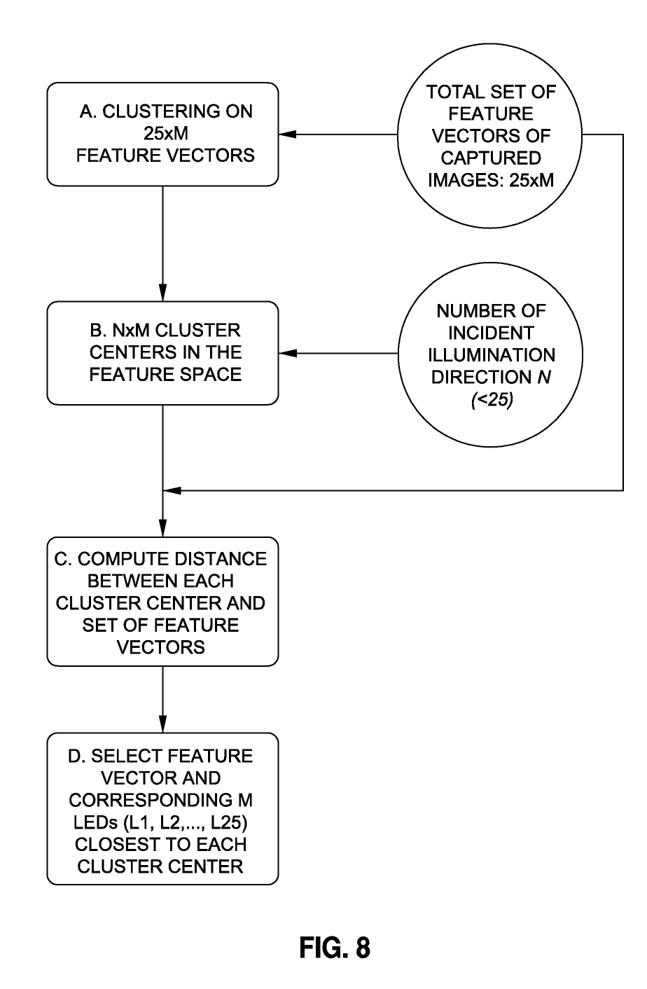

FIG. 8 is another view for explaining the framework of this embodiment, and is largely the same as the framework illustrated in FIG. 7. In FIG. 8, the variable M represents the number of different-colored spectral sources in each different light source. For example, referring to the hemispherical dome arrangement shown in FIG. 4, there may be twenty-five (25) light sources (221-1, 221-2, 221-3, . . . , 221-23, 221-24 and 221-25) arranged uniformly over a hemispherical dome, where each light source may include six (6) differently-colored LEDs arranged in a circular cluster consisting of colors blue, green, yellow, red, orange and white, with white arranged at the center of the cluster. In such an arrangement, M=6. It will be understood that M=6 is a non-limiting example, and that other values for M are possible, in correspondence to the constitution and arrangement of illumination light sources by which the training set is built.

Likewise, in FIG. 8, the variable N represents the desired number of different incident illumination directions for each different light source in the classification engine. More specifically, it is understood that according to the framework described herein, there is a selection of a subset of illumination angles for only a few light sources from a superset of illumination angles for many such light sources. For example, referring again to the hemispherical dome arrangement shown in FIG. 4, there may be twenty-five (25) light sources in the superset of light sources, but a subset of only three (3) such light sources is desired for the classification engine. In such an arrangement, N=3. It will be understood that N=3 is a non-limiting example, and that other values for N are possible, in correspondence to the constitution and arrangement of illumination light sources by which the training set is built, and in correspondence to the desired number of different incident illumination directions in the subset of illumination angles. The value of N in all cases is expected to be less than the number of illumination angles in the superset of light sources, such that in this example embodiment, N<25.

Turning more specifically to FIG. 8, a framework is illustrated for selecting N incident illumination angles using spectral BRDFs for material classification. At (a) in FIG. 8, there is clustering on the total set of feature vectors of captured images in the training set. In this example embodiment, which uses the images are obtained from the RIT dataset given by Gu in connection with citation [3] (see <http://compimg1.cis.rit.edu/data/metal/>), the dataset contains 10 samples in each of 10 main material categories to add up to 100 samples in total. Each material sample is imaged 150 times, once for each of the M=6 LEDs of the 25 illumination sources as described previously. Thus, there are 15000 images in the training database, where 15000=25×6 (i.e., M=6 LEDs)×100 (i.e., the number of samples). Feature vectors are developed for the captured images, and at (a) there is clustering on 25×M feature-vectors. The feature-vectors may be obtained by application of a feature vector algorithm, the mean computation in this case, on each of the spectral BRDF slices of a training sample.

At (b) of FIG. 8, given the number N of desired illumination angles, there is a determination of N M-dimensional cluster centers (N cluster centers of dimension M) in the feature space. More precisely, given the 25×M set of feature vectors for each training sample (for example, Aluminum1, Aluminum2, and so on, for the Aluminum material category and Copper1, Copper2, and so on, for the Copper material category) from (a), N M-dimensional clusters are determined, and the respective centers of each such cluster are thereafter determined in the feature space.

At (c) of FIG. 8, a distance is calculated between each of the N M-dimensional cluster centers (from (b) of FIG. 8) and each of the 25 M-dimensional feature vectors (from (a) of FIG. 8). One purpose of computing these distances is to allow selection of the M-dimensional feature vectors closest to the centers, as these selected M-dimensional feature vectors correspond to illumination light sources in the superset of light sources that can be selected as the subset of illumination light sources for the classification engine. The distance metric can be the Euclidean distance, L1 or other appropriate metrics.

At (d) of FIG. 8, given the distances computed at (c), the respective M-dimensional feature vectors closest to each cluster center are selected. Correspondingly, for each cluster center, there is a selection of the M LEDs in the light source corresponding to the selected M-dimensional feature vector, thus resulting in selection of a subset of N illumination angles for only a few light sources (first number of light sources) from a superset (here, 25) of illumination angles for many such light sources (second number of light sources).

A description will now be made as to how different feature vectors can be computed using the optimal LED clusters or incident illumination angles, and as to how feature vector computation and classification proceeds in this embodiment (i.e., the second explanation mentioned above).

Given a set of labeled training samples belonging to 2 different material categories, and the optimal N LED clusters (or incident illumination angles) as described in the previous section, the set of feature vectors can now be obtained which uses only N LED clusters. These are taken to be the low-level feature vectors computed using the spectral BRDF slices taken using the N×M-LED clusters. In the case of 2 LED clusters, a material sample would be represented by a 12D feature vector, for example, since there are M=6 LEDs in each cluster. This type of feature vector, and the algorithm therefor, is referred to as the “optimal” one, even though it might not be optimal in a strict mathematical sense.

A second type of feature vector considered is a high-level one. It is computed using the low-level features corresponding to the 150 spectral BRDF slices corresponding to all the LEDs, as described in (B) in the previous section. The approach used is similar in nature to the Bag-Of-Visual Words one used commonly in computer vision for image classification tasks. In this case, given the N clusters as computed in (C) of the previous section, a histogram over the clusters is computed for each material sample using its BRDF slices. For each of the 25×M aggregated features for one material, the distance is computed to each of the cluster means. Two types of distance measures are considered: the Euclidean distance (ED) and the L1. The histogram bin corresponding to the smallest distance measure is incremented by one. Therefore each material sample would be represented by a histogram of occurrence of the optimal clusters. As such, a material sample would be represented by an N-dimensional vector. Note again that the clusters from the previous section referred to here are obtained from (C) and not (D). This type of feature vector, and the algorithm therefor, is referred to as “histogram-based”.

The third type of feature vector tested in the classification algorithm is the low-level feature vector as described in (B) above. This type of feature vector, and the algorithm therefor, is referred to as the “mean” one.

A classification engine is then trained on multiple folds of training data and tested on the remaining folds. In the case of two material categories, where there are four (4) samples per category (8 samples in total), there would be 16 folds of training and testing data. For each fold, a training set would have 6 material samples, while a test set would have 2 samples. The classification accuracy computed is then taken to be the average over the test sets of the 16 folds. The classification engine can be either discriminative or generative. This embodiment uses an SVM (Support Vector Machine) classification engine, which is a discriminative classifier. Two items need to be set when using an SVM: the kernel type and the C parameter. Since the RIT dataset contains only a small number of training samples, use of a linear kernel is sufficient. However, in an alternate embodiment, an SVM classification engine was used with a radial kernel, with no significant difference (better or worse) in the results. As for the parameter C, it was set to 10.

A comparison was made amongst the results for the 3 feature vector representations described above. Tests were on the separation of aluminum versus copper, as well as the separation of brass versus copper. Table A shows the classification accuracies using the 3 types of feature vectors described for the aluminum and copper categories, where the number of optimal clusters selected is N=2 and N=3, respectively. Table B shows the classification accuracies using the 3 types of feature vectors described for the brass and copper categories, where the number of optimal clusters selected is N=2 and N=3, respectively. The best results obtained for each of the separation cases are highlighted by arrows surrounding the name of the feature vector algorithm that provides the best results, for example, “- ->Optimal (18D)<- -”.

TABLE A
Classification accuracies using the 3 types of feature
vectors described for the aluminum and copper categories,
where the number of optimal clusters selected is N =
2 (for the top four rows), and where the number of optimal
clusters selected is N = 3 (for the bottom four rows).

| | Number | Alumi- | Cop- | Over- |
|---|---|---|---|---|
| | of light | num | per | all |
| Feature Vector Type | sources | (%) | (%) | (%) |
| Optimal (12D) | 2 | 81 | 75 | 78 |
| Histogram-based, using ED metric (2D) | 2 | 75 | 100 | 88 |
| Histogram-based, using L1 metric (2D) | 2 | 75 | 88 | 81 |
| --> Optimal (18D) <-- (best results) | 3 | 94 | 94 | 94 |
| Histogram-based, using ED metric (3D) | 3 | 81 | 94 | 88 |
| Histogram-based, using L1 metric (3D) | 3 | 94 | 94 | 94 |
| Mean (150D) | 25 | 75 | 81 | 78 |

Table A thus shows classification accuracies obtained using an SVM with a linear kernel, for each of the aluminum, copper and then both categories, computed over 16 folds. Three types of feature vectors are considered: the optimal where the feature vectors are computed as the mean ones over the BRDF slices corresponding to the optimal LED clusters; the histogram-based where the feature vectors are computed as the number of occurrences of the estimated N clusters using the Euclidean distance metric and the L1 metric; and the mean feature vector computed as the concatenation of the means over all 150 slices. The number of selected clusters in this case is N=2 for the top four rows, and N=3 for the bottom four rows, as indicated in the table.

TABLE B
Classification accuracies using the 3 types of feature
vectors described for the brass and copper categories,
where the number of optimal clusters selected is N =
2 (for the top four rows), and where the number of optimal
clusters selected is N = 3 (for the bottom four rows).

| | Number | | | Over- |
|---|---|---|---|---|
| | of light | Brass | Copper | all |
| Feature Vector Type | sources | (%) | (%) | (%) |
| --> Optimal (12D) <-- (best results) | 2 | 100 | 94 | 97 |
| Histogram-based, using ED metric (2D) | 2 | 81 | 94 | 88 |
| Histogram-based, using L1 metric (2D) | 2 | 75 | 100 | 88 |
| Optimal (18D) | 3 | 75 | 100 | 88 |
| Histogram-based, using ED metric (3D) | 3 | 56 | 94 | 75 |
| Histogram-based, using L1 metric (3D) | 3 | 75 | 94 | 84 |
| Mean (150D) | 25 | 81 | 100 | 91 |

Table B thus shows classification accuracies obtained using an SVM with a linear kernel, for each of the brass, copper and then both categories, computed over 16 folds. Three types of feature vectors are considered: the optimal where the feature vectors are computed as the mean ones over the BRDF slices corresponding to the optimal LED clusters; the histogram-based where the feature vectors are computed as the number of occurrences of the estimated N clusters using the Euclidean distance metric and the L1 metric; and the mean feature vector computed as the concatenation of the means over all 150 slices. The number of selected clusters in this case is N=2, for the top four rows, and N=3 for the bottom four rows, as indicated in the table.

Generally, accuracy percentages listed in Tables A and B are calculated by dividing the number of correctly classified test samples by the total number of test samples. For example, in the case of 10 brass test samples, if the number of test samples correctly classified as brass is 6 and the total number of brass samples is 10, the classification accuracy is 60%. Furthermore, for purposes of this description, the classification accuracy was computed sixteen (16) times for different combinations of training and test samples. Therefore the classification accuracies reported in the tables are the means over the accuracies computed for all the folds. This is a metric commonly used in the art, for evaluating classification algorithms.

Representative incidence angles found for the light sources, for each case, are set out below. Each angle is given using three (3) coordinates in degrees. Each coordinate is the angle between the radius vector and one of the three coordinate axes. The radius vector is drawn from the (0, 0, 0) center to the light source.

Aluminum versus Copper:

N=2: (118°, 84°, 29°) and (119°, 70°, 36°)

N=3: (116°, 84°, 27°), (119°, 70°, 36°), and (63°, 46°, 55°)

Brass versus Copper:

N=2: (119°, 70°, 36°), (63°, 46°, 55°)

N=3: (119°, 70°, 36°), (63°, 46°, 55°), and (102°, 88°, 13°)

As noted above, the classification engine used in this embodiment is an SVM-based classification engine. As compared to the classification considered by Gu in citation [2], citation [2] uses two classification algorithms, one of which is SVM-based. The description of classification engines herein does not compare directly to the classification used by Gu in citation [2] for the reason that Gu uses the optimal two shots (as computed by their algorithm) to capture the images they use in classification. Therefore they capture only two images of their materials with different combinations of LEDs; however they do not provide these images. They only provide images taken under each LED independently, so 150 images captured under 150 LEDs. Furthermore, their classification treats each pixel as a sample independently, while the classification engine herein takes each stack of 150 images for one material to be one sample. Experiments were performed on per-pixel classification of material samples but results of those experiments are not included herein at least in part for the reasons listed above.

With respect to the incident illumination angles corresponding to the optimally-selected light sources, the optimal clusters or their corresponding angles are selected from the original ones in the dome, which has 25 LED clusters or equivalently 25 angles in total. The optimal angles computed by the algorithm proposed in the MOI are different for different sets of materials. For a given set of training samples, K-means clustering is performed to obtain N=2 or N=3 clusters of angles. These clusters are estimated by the K-means algorithm and therefore their means do not directly correspond to any of the angles in the dome. Afterwards (in step (D) of the FIG. 7 workflow) the cluster means are mapped to the angles of the dome using a minimum distance metric.

As shown in the above Table A, N=3 is apparently better than N=2 for the classification of aluminum versus copper, which seems consistent with intuitive expectations. On the other hand, as shown in the above Table B, N=2 is apparently better than N=3 for classification of brass versus copper, which seems to be a non-intuitive result since it might be expected that a larger number of N is better than smaller number of N. From a physical standpoint, it might indeed be expected that the case of N=3 should be better than the case N=2. However, the mathematical clustering technique is data-driven. Therefore, it learns its parameters based on a set of input data, and then classifies test data. Additionally, the parameter C which is set manually also plays a role in the parameter estimation (or learning) process. This is generally the case in machine learning algorithms. Although the value of the parameter C was varied experimentally, and automatically, the results did not differ significantly. It is thought that the non-intuitive result of better classification at N=2 as compared with N=3 might be attributed to the fact that in machine learning, sometimes increasing the dimensionality of the feature space does not necessarily result in a better classification algorithm.

Among the conclusions that might be drawn from these results are the following two conclusions. First, the optimal number of illumination angles is at least partly dependent on the material categories considered, as expected. For separating aluminum from copper, the case of N=3 consistently provides classification performance on par with or superior to the case of N=2. For separating brass from copper, the case of N=2 consistently provides classification performance on par with or superior to the case of N=3. Second, it can generally be concluded that the classification accuracies using the optimal feature vectors are generally superior to the accuracies when using other types of feature vectors. The optimal feature vectors correspond to the incident illumination angles selected by the mathematical clustering approach described herein.

Among the advantages provided by the embodiments and description herein is the advantage of determining a minimal subset of light sources from among a superset of light sources, and corresponding incident illumination angles, which can be used to image materials without compromising on material classification accuracy. As the number of light sources increases, there is a geometric increase in the complexity of building, maintaining and using a material classification system, and a geometric increase in the time and processing power required for accurate classification results.

Other advantages include a reduction in the number of images captured and consequently the dimensionality of the feature vectors needed to represent the materials in the classification algorithm. This would result in decreasing both the training and test time. Decreasing the training time would be useful in case of deployment of an online training material classifier. Decreasing the test time can be important when a classifier is deployed in a factory setting for recycling.

### Other Embodiments

According to other embodiments contemplated by the present disclosure, example embodiments may include a computer processor such as a single core or multi-core central processing unit (CPU) or micro-processing unit (MPU), which is constructed to realize the functionality described above. The computer processor might be incorporated in a stand-alone apparatus or in a multi-component apparatus, or might comprise multiple computer processors which are constructed to work together to realize such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. For these purposes, access to the non-transitory computer-readable storage medium may be a local access such as by access via a local memory bus structure, or may be a remote access such as by access via a wired or wireless network or Internet. The computer processor(s) may thereafter be operated to execute the computer-executable program or program steps to perform functions of the above-described embodiments.

According to still further embodiments contemplated by the present disclosure, example embodiments may include methods in which the functionality described above is performed by a computer processor such as a single core or multi-core central processing unit (CPU) or micro-processing unit (MPU). As explained above, the computer processor might be incorporated in a stand-alone apparatus or in a multi-component apparatus, or might comprise multiple computer processors which work together to perform such functionality. The computer processor or processors execute a computer-executable program (sometimes referred to as computer-executable instructions or computer-executable code) to perform some or all of the above-described functions. The computer-executable program may be pre-stored in the computer processor(s), or the computer processor(s) may be functionally connected for access to a non-transitory computer-readable storage medium on which the computer-executable program or program steps are stored. Access to the non-transitory computer-readable storage medium may form part of the method of the embodiment. For these purposes, access to the non-transitory computer-readable storage medium may be a local access such as by access via a local memory bus structure, or may be a remote access such as by access via a wired or wireless network or Internet. The computer processor(s) is/are thereafter operated to execute the computer-executable program or program steps to perform functions of the above-described embodiments.

The non-transitory computer-readable storage medium on which a computer-executable program or program steps are stored may be any of a wide variety of tangible storage devices which are constructed to retrievably store data, including, for example, any of a flexible disk (floppy disk), a hard disk, an optical disk, a magneto-optical disk, a compact disc (CD), a digital versatile disc (DVD), micro-drive, a read only memory (ROM), random access memory (RAM), erasable programmable read only memory (EPROM), electrically erasable programmable read only memory (EEPROM), dynamic random access memory (DRAM), video RAM (VRAM), a magnetic tape or card, optical card, nanosystem, molecular memory integrated circuit, redundant array of independent disks (RAID), a nonvolatile memory card, a flash memory device, a storage of distributed computing systems and the like. The storage medium may be a function expansion unit removably inserted in and/or remotely accessed by the apparatus or system for use with the computer processor(s).

This disclosure has provided a detailed description with respect to particular representative embodiments. It is understood that the scope of the claims directed to the inventive aspects described herein is not limited to the above-described embodiments and that various changes and modifications may be made without departing from the scope of such claims.

This disclosure has been presented for purposes of illustration and description but is not intended to be exhaustive or limiting. Many modifications and variations will be apparent to those of ordinary skill in the art who read and understand this disclosure, and this disclosure is intended to cover any and all adaptations or variations of various embodiments. The example embodiments were chosen and described in order to explain principles and practical application, and to enable others of ordinary skill in the art to understand the nature of the various embodiments. Various modifications as are suited to particular uses are contemplated. Suitable embodiments include all modifications and equivalents of the subject matter described herein, as well as any combination of features or elements of the above-described embodiments, unless otherwise indicated herein or otherwise contraindicated by context or technological compatibility or feasibility.

1. A method for selecting incident illumination angles for illumination of an object by respective light sources, wherein the incident illumination angle of each light source is selected based on a mathematical clustering analysis of labeled training data captured under a superset of a second number of light sources light sources from different incident angles, so as to select a subset of incident illumination angles by a first number of light sources from the superset of the second number of light sources, the first number being smaller than the second number.

2. The method according to claim 1, further comprising:
calculating a feature vector representation for training data in a database of labeled training data captured under the superset of the second number of light sources from different incident angles;
performing mathematical clustering on the feature vector representations so as to identify a subset of mathematically significant clusters of data for a corresponding the first number of incident illumination angles; and
selecting incident illumination angles for the light sources based on the mathematical clusters.

3. The method according to claim 2, wherein directions for the incident illumination angles for the light sources are selected using a distance metric selected from a group consisting essentially of a Euclidean distance metric and an L1 distance metric.

4. The method according to claim 2, wherein the mathematical clustering includes clustering by a clustering algorithm selected from a group consisting essentially of K-means clustering and Gaussian Mixture Models clustering.

5. The method according to claim 2, further comprising usage of BRDF (bidirectional reflectance distribution function) slices.

6. The method according to claim 5, wherein the feature vectors comprise means of intensities of the BRDF slices.

7. The method according to claim 6, wherein the feature vectors comprise histograms over features of the spectral BRDF slices of a training sample.

8. The method according to claim 2, wherein the training data is captured from a superset of a relatively large number of exitant angle, and wherein the method further comprises selecting a subset of a relatively small number of mathematically significant clusters of data for a corresponding small number of exitant angles by using mathematical clustering.

9. The method according to claim 2, wherein the number of mathematically significant clusters is selected automatically using a mathematical clustering algorithm which includes convex clustering.

10. The method according to claim 2, wherein each light source in the database of labeled training data comprises a multi-spectral light source, and wherein the method further comprises selecting a subset of a relatively small number of mathematically significant clusters of illumination spectra for subset of incident illumination angles by using mathematical clustering.

11. The method according to claim 2, wherein the illuminated object is fabricated from an unknown material and is illuminated by the light sources for material classification, and wherein the method further comprises:
training a classification engine for material classification, wherein the classification engine is trained using feature vectors calculated from training data corresponding to light sources for the selected incident angles.

12. The method according to claim 11, wherein the classification engine includes an SVM (support vector machine) algorithm.

13. The method according to claim 11, wherein the classification engine is configured to make a decision for cases with a pre-determined level of confidence, and in response to failure of the classification engine to make a decision with confidence by the engine, the object is subjected to manual labeling, and the training for the classification engine is updated using the manually-classified result.

14. The method according to claim 11, further comprising:
capturing reflected light information from an object of unknown material illuminated in an imaging configuration that includes the selected optimal light source directions; and
applying the trained classification engine to the captured light information to classify the material of the illuminated object.

15. An apparatus for selecting incident illumination angles for illumination of an object by respective light sources, comprising:
memory for storing computer-executable process steps and for storing labeled training data; and
one or more processors for executing the computer-executable process step stored in the memory;
wherein the computer-executable process steps include steps wherein the incident illumination angle of each light source is selected based on a mathematical clustering analysis of labeled training data captured under a superset of a second number of light sources light sources from different incident angles, so as to select a subset of incident illumination angles by a first number of light sources from the superset of the second number of light sources, the first number being smaller than the second number.

16. An apparatus for material classification of an object fabricated from an unknown material, comprising:
memory for storing computer-executable process steps; and
one or more processors for executing the computer-executable process step stored in the memory;
wherein the computer-executable process steps include steps to:
illuminate an object by spectral light from multiple different incident angles using multiple light sources;
measure light reflected from the illuminated object; and
classify the material from which the object is fabricated using the measured reflected light;
wherein the incident illumination angle of each light source is selected based on a mathematical clustering analysis of labeled training data captured under a superset of light sources from different incident angles, so as to select a subset of incident illumination angles by first number of light sources from a superset of second number of light sources, the first number being smaller than the second number.

17. The apparatus according to claim 16, wherein classification comprises applying a trained classification engine to the captured light information to classify the material of the illuminated object.

18. The apparatus according to claim 16, wherein the classification engine is trained using feature vectors calculated from training data corresponding to light sources for the selected incident angles.

19. The apparatus according to claim 17, wherein the classification engine is trained multiple times for updating of its training by new material samples.

20. An apparatus for material classification of an object fabricated from an unknown material, comprising:
memory for storing computer-executable process steps; and
one or more processors for executing the computer-executable process step stored in the memory;
wherein the computer-executable process steps include steps to:
illuminate an object positioned at a classification station by plural light sources each positioned at a predesignated incidence angle with respect to the object;
capture plural images of light reflected from the illuminated object, each of the plural images corresponding respectively to illumination by a respective one of the plural light sources;
extract a respective plurality of feature vectors from the plural captured images by using a feature vector algorithm; and
process the plurality of feature vectors using a trained classification engine so as to classify the unknown material of the object;
wherein the predesignated incident angles are determined by:
calculating a feature vector representation for training data in a database of labeled training data captured under a superset of a second number of light sources light sources from different incident angles, so as to select a subset of incident illumination angles by a first number of light sources from the superset of the second number of light sources, the first number being smaller than the second number, wherein the feature vector is calculated using the feature vector algorithm;
performing mathematical clustering on the feature vector representations so as to identify a subset of mathematically significant clusters of data for a corresponding first number of incident illumination angles; and
selecting incident illumination angles for the light sources based on the mathematical clusters;
and wherein the classification engine is trained by using feature vectors calculated from training data corresponding to light sources for the selected incident angles.
